(19) United States
(12) Patent Application Publication
(10) Pub. No.: US 2021/0372177 A1
(43) Pub. Date: Dec. 2, 2021

(54) Composite material useful to facilitate molding light weight hinge elements cobonded to adjoining substrates

(71) Applicant: Robert W. Miller, Huntington Beach, CA (US)

(72) Inventor: Robert W. Miller, Huntington Beach, CA (US)

(21) Appl. No.: 16/873,653

(22) Filed: Jun. 1, 2020

(51) Int. Cl. E05D 1/00; B32B 5/02; B32B 7/12

(52) U.S. Cl. CPC E05D 1/00; B32B 5/024; B32B 7/12; E05Y 2900/20; E05Y 2800/676; E05Y 2900/132; B32B 2262/0284

(57) ABSTRACT

A composite-material and methods used to produce low profile close tolerance composite-hinges such as required for desks and cabinets, that can be molded and bonded into structures using specified resin systems in a simple layup and cure.

The reinforcement material of the hinge is PET fiber-fabric, that is plied with a thin film of a polymeric adhesive-tape. The tape will serve as the exterior face of a molded hinge. The reinforcement fiber material will be oriented at +/−45 degrees to hinge line for maximum shear stiffness. The hinge material will be infused with a laminating/adhesive resin in the lay-up process to produce a co-molded hinge bonded to the structural substrates. This composite material and described process will yield installed low-profile (10 mil) hinges that have a typical tensile strength of 74 lbs/inch of length.

A resin-septum coating template would be supplied with the raw material to facilitate the process. The template material is a screen that will act as a septum to hold a proscribed layer of the laminating-adhesive resin in position to facilitate the infusion of resin to the fiber-fabric face of coupon to produce the composite-hinge, co-bonded to the substrates. The composite material could be supplied as trimmed to size hinge-coupons, or in 5 foot lengths of standard width material to be trimmed as required by user.

### FIELD OF INVENTION

The present invention relates to the material and method of use to produce light duty hinges that are co-molded with substrates of the door and frame, in a single cure step. This application describes potential applications for this product in the woodcraft industry where the laminating adhesive resins are typically room temperature cure resins. However this described hinge material and method could be used with other resin systems for various industries.

Description of Prior Art Hinges are traced back to early civilizations where the hinges that rotated the heavy wood doors used a pivot bearing hinge that comprised a hole in the stone floor and a wood pivot-pin. The metal strap hinges that replaced the pivot hinges have been used for centuries and are still used today, but are just one of the wide variety of hinges available.

However, the development of new types of hinges with special requirements for mortise machine cuts, and tight installation dimension tolerances can result in substantial material and installation costs.

### SUMMARY OF THE INVENTION

Accordingly, it is the general purpose and object of the present invention to provide a composite hinge material that can be used to quickly produce low weight, low-profile hinges installed in a single cure. This inventive hinge material is an assembly of a woven 3.0 oz/square yard fabric of a high strength PET Dacron fiber, plied with a 3-4 mil paintable polymeric adhesive tape to one side of the dry fabric. This combination of plying the adhesive tape to the dry fabric provides stability to the loose weave fabric, producing a material that can readily be handled for the layup and molding steps to produce hinges that are molded and integrally bonded onto the wood substrates in a single step.

The above described plied reinforcement material will be coated with a laminating adhesive resin to produce a composite hinge laminate, and in the same cure step, bond the hinge laminate to the adjoining substrates for the hinge. The fiber orientation in the laminate is oriented at +/−45 degrees to the hinge line to obtain maximum shear strength and stiffness. The resultant installed hinges are lite-weight, durable, structural bonded assemblies. This composite-hinge material produces tight tolerance installed hinges. Butt-hinged joints would have a standard clearance of zero inches, and no mortise cutouts.

This Composite Hinge material for typical wood cabinet construction could be supplied in strips of long lengths of a specified width (1.5 inch) to be cut to coupon lengths required by the user. This would yield hinges with ¾ inch-wide leaves and required length. The profile height of these hinges installed will be 10 mils. The same material could produce ½ inch long butt-hinges or a 6 foot piano hinge.

The polymeric tape ply of the composite assembly becomes permanently bonded to the hinge as the resin cures, and will serve as a paintable protective layer to the hinge.

The adhesive laminating resins recommended for use for producing these hinges for wood structures are industry standard, PVA based resin systems, “Titebond II and III”. Limited further testing showed that the contact-adhesive “Pliobond”, also could work well.

This specification also describes the following shop-aid tools that can be used for processing the composite hinge material—

1.A. Roller Compacting Tool—A hand held roller tool described in Design Patent Application #29/742,144. The surface of the roller is a water-resistant rubber-cork material and is used as a tool to massage the installed hinge coupons to remove any trapped air, and consolidate laminate. The roller will use a low friction axle to provide a roller assembly that can roll across the uncured hinge layup without inducing slippage between the substrates and hinge coupon of the plied material. The installation process for these hinges closely contains the adhesive resin, so that there typically is no significant amount of resin bleeding out the hinge assembly. Resin that may contaminate the cork roller can be quickly removed with a damp towel. After the installation is complete, the roller can be placed in warm water to remove any uncured resin. Rinse and damp dry, and the roller is ready for re-use.

1.B. Resin Septum Roller Tool—This tool is basically same as the cork roller described in section 1.A above, except the roller for this tool will have a surface that uses the same screen material as described in section 2. This roller can used to distribute and/or smooth out resin applied to a substrate. Tool is quickly cleaned in warm water, and is reusable. It can also serve as a smooth roller to massage a completed hinge-coupon installation.

2. Resin Coating Template—A shop-aid tool is described that will enable the users to have a guide-tool for applying the laminating-adhesive resin onto the substrates for the hinge coupon. The template for this application will use a standard vinyl/fiberglass screen with a 0.50 inch tab-handle at one end. See FIG. 3.

In use, the template will be laid onto the marked position for hinge that has a light coat of the wet adhesive resin applied. The viscous adhesive resin on the substrate will seal that first side of the template to the substrate, leaving the opposite side to have an open cellular face that will be brush-coated with additional resin. The filled template will hold the laminating-adhesive resin needed to mold the composite-hinge. After a 5 minute pause, the template will be pulled-up from the substrates, leaving a 4-5 mil thickness of the adhesive resin positioned for the application of the hinge coupon. As the hinge-coupon is applied to that surface, the adhesive forces of the adhesive resin will secure the coupon and infuse the reinforcement fiber to mold the hinge laminates and structurally bond the hinge elements to the abutted substrates.

3. Coupon Harness The purpose of Harness tool is to facilitate accurate positioning of the hinge-coupon that will be placed on the marked position on the substrates for installation of a Composite-Hinge. This is a DIY item that simply uses a short (˜2.5 inch) section of a craft-stick (or coffee-stick) crossed at middle with a 2.0 inch length of 1 inch wide masking tape. To pick up a hinge-coupon, the tool is placed on the poly-face of coupon and the masking tape is smoothed to the surface. The craft-stick of harness tool would be held with thumb and forefinger of one-hand to facilitate positioning the Coupon to the substrates. The Coupon-Hinge would then be smoothed down to the substrates with opposite hand.

4. Installed Hinge Cosmetics—Several observers expressed concerns about the visible mark-off of the thin square edge around our hinge specimens. We have demonstrated a version of a hinge coupon that extends the length of the polymeric face material ˜0.2 inch beyond edge of the fiber reinforcement of the hinge. This provides a smooth feather-edge that is practically unseen on a painted surface. We have added this option as a dependent claim. See claim 4.

### DRAWINGS

FIG. 1 perspective of Composite-Hinge Material

FIG. 2 deleted

FIG. 3 Resin-Coating Template

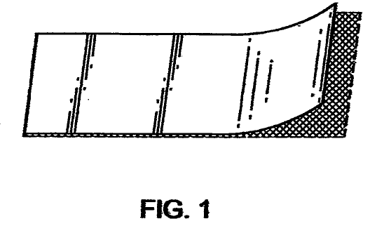

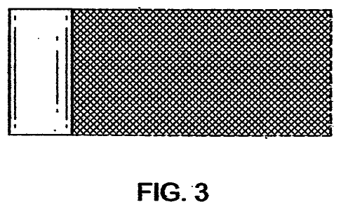

### INSTALLATION—TOOLS/PREPARATIONS

Shop-Aid Tools—Horse-hair acid brush, Resin Coating Template, Coupon Harness, Cork Roller, Screen Roller tool
1. Pre-fit the two substrates snug together.

Note: For bonding cycle, abutted substrates can be held together by masking tape.
2. Mark the position for the hinge on the abutted substrates
3. Paint a light coat of the adhesive resin onto the marked area.

Installation—Method
A. Over-lay the Resin Coating Template onto the wet resin. The adhesive will hold the template in required position. The cellular surface of template will act as a septum for the resin that will impregnate, mold and bond the composite-hinge in place.
B. Brush-coat resin onto template to fill pores of the septum-screen. Pause 4-5 minutes and remove template, which will leave a 4-5 mil thickness of resin on the substrates.
C. Use the harness to pick-up the hinge-coupon for lay-up onto substrates. Align the coupon to position with one hand and lightly place first end down to position. Sequentially smooth coupon down to opposite end using the free hand.
D. The resin will rapidly infuse the fiber of the overlaid coupon and secure it to the substrate. The described roller tools can be useful to remove any trapped air in laminate and insure that hinge-coupon is flush to substrate. Allow cure times per supplier instructions.

### Notes—

1. The high-cohesive forces in these adhesive resins serves to consolidate the resultant laminate. Placing additional clamping pressures on installed hinge-coupons is not recommended, as it will typically result in sliding the coupon out of position.
2. To massage a newly installed coupon, you will need to hold the coupon in position with two fingers to prevent slippage.

It is claimed:

1. A unique composite material assembly that is useful to produce low-profile hinges (10 mil thickness) that are molded and installed in a single cure step.
This composite material comprises:
A. High strength light weight fabric, such as PET or Aramid, that is plied with a high strength film, such as bondable PVF, or a aramid paper. The fiber orientation of the fabric will be oriented to be +/−45 degrees across hinge line.
B. The impregnating resin for use on wood structures would typically be industry-proven 4000 cps PVA based room temperature cure resin systems.
C. The impregnating resin for use with for metal or composite structures would typically be high temp-cure laminating adhesives.

2. A version of the Composite-Hinge material that would have the polymeric face material extend slightly beyond the edge of the fiber fabric reinforcement. In the laminating/bonding cycle this will produce a feathered-edge to installed coupon.
